(19) United States
(12) Patent Application Publication
(10) Pub. No.: US 2007/0197340 A1
(43) Pub. Date: Aug. 23, 2007

(54) Internal ring gear with integral hub portion and method of manufacture

(76) Inventors: Young Sik Kim, Canton, MI (US); Fredrick R. Poskie, Plymouth, MI (US); James W. Haynes, Saline, MI (US); Mary T. Lapres-Bilbrey, Brighton, MI (US); Kenneth L. Navarre, Bellaire, MI (US)

Correspondence Address: CHRISTOPHER DEVRIES;General Motors Corporation, Legal Staff, Mail Code 482-C23-B21, P.O. Box 300, Detroit, MI, 48265-3000, US

(21) Appl. No.: 11/416,895

(22) Filed: May 3, 2006

Related U.S. Application Data
(60) Provisional application No. 60/774,575, filed on Feb. 17, 2006.

(51) Int. Cl. F16H 57/08

(52) U.S. Cl. 475/344; 475/331

(57) ABSTRACT

A planetary gearset is provided having an internal ring gear with a plurality of generally radially inwardly extending teeth in meshing engagement with at least one pinion gear. A hub portion extends generally radially inwardly from the internal ring gear. The internal ring gear and the hub portion are integrally formed. Additionally, the internal ring gear and hub portion may be integrally formed by one of a spinning operation, powdered metal compaction, and cold extrusion.

### CROSS REFERENCE TO RELATED APPLICATION

This application claims the benefit of U.S. Provisional Application No. 60/774575, filed Feb. 17, 2006, which is hereby incorporated by reference in its entirety.

### TECHNICAL FIELD

The present invention relates to internal ring gears for automatically shiftable vehicular transmissions and more specifically to an internal ring gear having a hub formed integrally therewith and a method for manufacturing same.

### BACKGROUND OF THE INVENTION

The use of planetary gearsets within automatically shiftable vehicular transmissions is well known in the vehicular art. In order to achieve a desired output speed from the automatically shiftable vehicular transmission, the transmission will receive input from a power source, such as an internal combustion engine, and convert the imparted input energy to an output torque. Such a transmission will typically employ one or more planetary gearsets that may be connected between a torque converter and an output shaft of the transmission. Each planetary gearset includes a sun gear, an internal ring gear, and a plurality of planet (or pinion) gears, operatively supported on a carrier, to meshingly interconnect the sun and internal ring gear. Various torque transmitting mechanisms in the nature of clutches and brakes are utilized in combination with the planetary gearsets to control the relative rotation of one or more components thereof and thereby produce the desired drive ratios.

The internal ring gear may be rigidly affixed to a hub member, which may form a portion of the carrier of another planetary gearset or may be splined to a shaft for unitary rotation therewith. Typical methods of attaching the internal ring gear to the hub member may include welding, castellations, and splines. To attach the internal ring gear to the hub member by welding, the internal ring gear and the hub member are formed separately and are subsequently joined though a variety of commercial welding techniques. These welding techniques may include MIG, TIG, electron beam, submerged arc welding, laser welding, etc. To attach the internal ring gear to the hub member using castellations, the internal ring gear and hub member are each formed with a plurality of radially extending, meshingly engageable castellations. These castellations provide radial location and torque transmitting capabilities between the internal ring gear and the hub member. A snap ring is provided to limit the relative axial movement between the internal ring gear and the hub member. To attach the internal ring gear to the hub member using splines, the internal ring gear and hub member are each formed with a plurality of radially extending, meshingly engageable splines. These splines provide radial location and torque transmitting capabilities between the internal ring gear and the hub member. Similar to the castellation attachment technique a snap ring is provided to limit the relative axial movement between the internal ring gear and the hub member.

### SUMMARY OF THE INVENTION

A planetary gearset is provided having an internal ring gear portion with a plurality of generally radially inwardly extending teeth in meshing engagement with at least one pinion gear and a hub portion extending generally radially inwardly from the internal ring gear. The internal ring gear portion and the hub portion are integrally formed. The plurality of radially inwardly extending teeth may be helical in form. Additionally, the hub portion may be splined and form a portion of at least a portion of a carrier assembly of the planetary gearset. The internal ring gear portion and the hub portion may be formed by one of spinning, powdered metal compaction, and cold extrusion.

Additionally, A method of integrally forming an internal ring gear and hub portion is provided. The method includes fixturing a blank and forming the internal ring gear integrally with the hub portion. Fixturing the blank may include securing the blank to a mandrel having a shaped outer contour defining a tooth portion sufficiently configured to complement gear teeth on the internal ring gear. Subsequently, the internal ring gear is formed integrally with the hub portion by rotating the mandrel unitarily with the blank and urging the blank against the shaped outer contour with a forming head. Alternatively, fixturing the blank may include placing the blank within a cavity defined by a cold extrusion press. The cold extrusion press includes a die having shaped outer contour defining a tooth portion sufficiently configured to form complementary gear teeth on the internal ring gear. Subsequently, the internal ring gear is formed integrally with the hub portion by pressing the die against the blank with sufficient force to urge the blank against the shaped outer contour.

Another method of integrally forming the internal ring gear and hub portion is provided. The method includes placing a predetermined amount of powdered metal within a press, such as a double acting press, and compacting the predetermined amount of powdered metal within the press with sufficient pressure to form the internal ring gear integrally with the hub portion. The press may include a first die and a second die. The first die has a shaped outer contour defining a tooth portion sufficiently configured to form complementary gear teeth on the internal ring gear during compacting.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a cross sectional view of a portion of an automatically shiftable vehicular transmission illustrating planetary gearsets having integrally formed internal ring gears and hub portions consistent with the present invention;

FIG. 2 is a partial side view of a spinning fixture operable to integrally form the internal ring gear and hub portion of FIG. 1;

FIG. 3 is a partial side view of the spinning fixture shown in FIG. 2 with the integrally formed internal ring gear and hub portion;

FIG. 4 is a partial side view of a press operable to integrally form the internal ring gear and hub portion of FIG. 1 by powdered metal compaction;

FIG. 5 is a partial side view of the press shown in FIG. 4 with the integrally formed internal ring gear and hub portion;

FIG. 6 is a partial side view of a press operable to integrally form the internal ring gear and hub portion of FIG. 1 by cold extrusion; and

FIG. 7 is a partial side view of the press shown in FIG. 6 with the integrally formed internal ring gear and hub portion.

### DESCRIPTION OF THE PREFERRED EMBODIMENTS

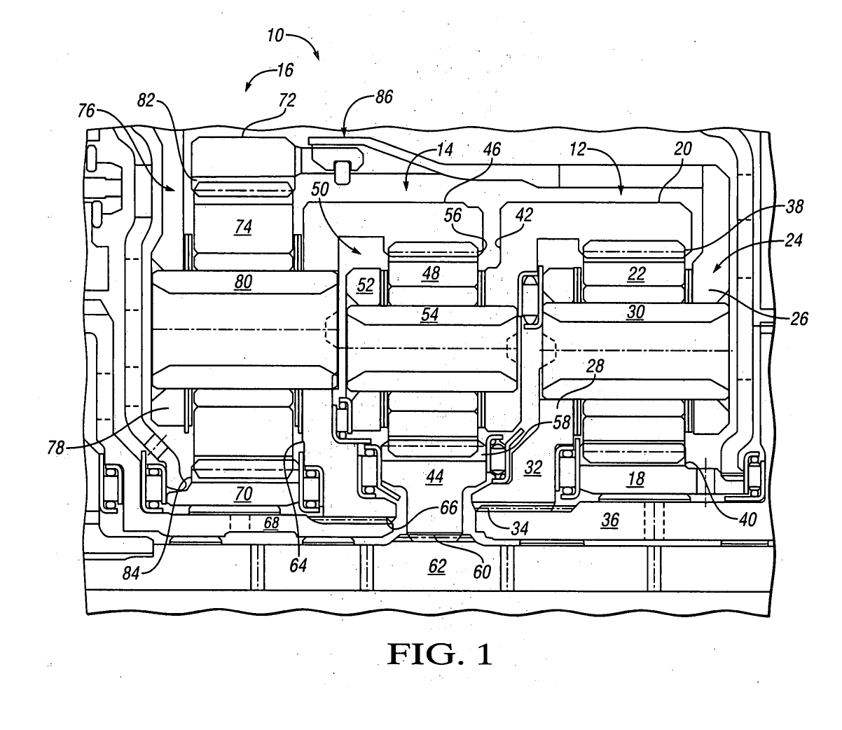

Referring to the drawings wherein like reference numbers correspond to like or similar components throughout the several figures, there is shown in FIG. 1 a portion of an automatically shiftable vehicular transmission, generally designated at 10. The transmission 10 includes a first planetary gearset 12, a second planetary gearset 14, and a third planetary gearset 16. The first planetary gearset 12 includes a sun gear 18, an internal ring gear 20 and a plurality of planet, or pinion, gears 22, one of which is shown in FIG. 1. The pinion gears 22 are rotatably supported by a carrier assembly 24. The carrier assembly 24 includes a pair of spaced sidewalls 26 and 28 and a plurality of pins 30, one of which is shown in FIG. 1, upon which a respective pinion gear 22 is rotatably supported. The first and second sidewalls 26 and 28, respectively, of the carrier assembly 24 are sufficiently configured to receive pins 30 and are secured together for unitary rotation. The second sidewall 28 has a hub 32 which has a splined, cylindrical inner surface 34 sufficiently configured to receive a splined sleeve shaft 36 such that the carrier assembly 24 and the sleeve shaft 36 rotate unitarily. The internal ring gear 20 is generally annular in shape and includes a plurality of radially inwardly extending helical gear teeth 38 sufficiently configured to meshingly engage the pinion gears 22. Similarly, the sun gear 18 includes a plurality of radially outwardly extending helical gear teeth 40 sufficiently configured to meshingly engage the pinion gears 22. Formed integrally with the internal ring gear 20 is a hub portion 42. The hub portion 42 extends generally radially inwardly form the internal ring gear 20.

The second planetary gearset 14 includes a sun gear 44, an internal ring gear 46 and a plurality of pinion gears 48, one of which is shown in FIG. 1, that are rotatably supported by a carrier assembly 50. The carrier assembly 50 includes a sidewall 52 spaced from the hub portion 42 and a plurality of pins 54, one of which is shown in FIG. 1, upon which a respective pinion gear 48 is rotatably supported. As shown in FIG. 1, the hub 42 forms a second sidewall of the carrier assembly 50. The sidewall 52 of the carrier assembly 50 and the hub 42 are sufficiently configured to receive pins 54 and are secured together for unitary rotation. The internal ring gear 46 is generally annular in shape and includes a plurality of radially inwardly extending helical gear teeth 56 sufficiently configured to meshingly engage the pinion gears 48. Similarly, the sun gear 44 includes a plurality of radially outwardly extending helical gear teeth 58 sufficiently configured to meshingly engage the pinion gears 48. The sun gear 44 has a splined, cylindrical inner surface 60 sufficiently configured to receive a splined shaft 62 such that the sun gear 44 and the shaft 62 unitarily rotate. Formed integrally with the internal ring gear 46 is a hub portion 64. The hub portion 64 extends generally radially inwardly form the internal ring gear 46. The hub portion 64 has a splined, cylindrical inner surface 66 sufficiently configured to receive a splined sleeve shaft 68 such that the hub portion 64 and the sleeve shaft 68 rotate unitarily.

The third planetary gearset 16 includes a sun gear 70, an internal ring gear 72, and a plurality of pinion gears 74, one of which is shown in FIG. 1, that are rotatably supported by a carrier assembly 76. The carrier assembly 76 includes a sidewall 78 spaced from the hub portion 64 and a plurality of pins 80, one of which is shown in FIG. 1, upon which the pinion gears 74 are rotatably supported. As shown in FIG. 1, the hub portion 64 forms a second sidewall of the carrier assembly 76. The sidewall 78 of the carrier assembly 76 and the hub 64 are sufficiently configured to receive pins 80 and are secured together for unitary rotation. The internal ring gear 72 is generally annular in shape and includes a plurality of radially inwardly extending helical gear teeth 82 sufficiently configured to meshingly engage the pinion gears 74. Similarly, the sun gear 70 includes a plurality of radially outwardly extending helical gear teeth 84 sufficiently configured to meshingly engage the pinion gears 74.

The sleeve shafts 68 and 36 are coaxially aligned, and rotatably supported by shaft 62. Additionally, the sun gears 18 and 70 are coaxially aligned and rotatably supported by sleeve shafts 36 and 68, respectively. The first sidewall 26 is connected with the ring gear 72 for unitary rotation therewith through a castellated joint 86.

Preferably, the internal ring gears 20 and 46 with the respective integrally formed hub portions 42 and 64 are net formed. A net formed part generally describes a part that requires very little if any post formation finish machining processes. By using a net forming process, the internal ring gears 20 and 46 and the respective integrally formed hub portions 42 and 64 are formed to be strong, inexpensive, and durable.

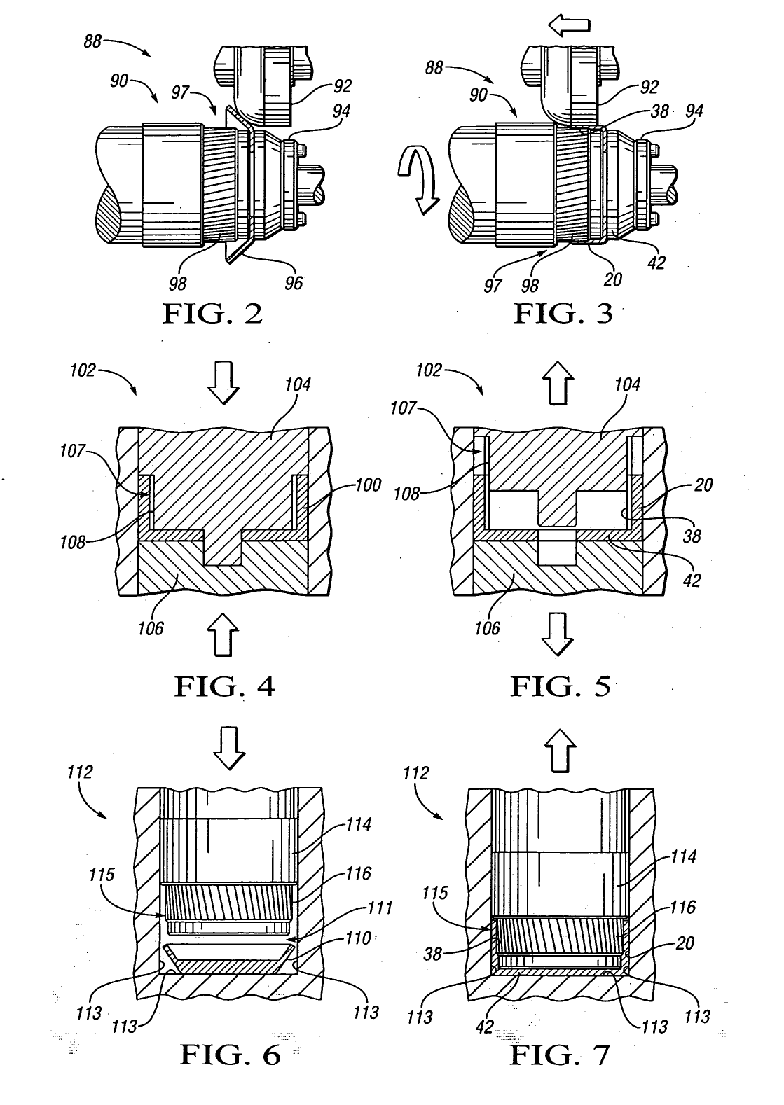

For purposes of clarity, the preferred methods of integrally forming the internal ring gear 20 and hub portion 42 will be discussed. However, those skilled in the art will recognize that the forming techniques described herinbelow may be readily applied to integrally form the internal ring gear 46 and hub portion 64 as well. Referring to FIGS. 2 and 3 there is shown a flow forming or spinning fixture 88 operable to form the internal ring gear 20 and hub portion 42 with a near net shape. The spinning fixture 88 includes a rotatable mandrel 90 and at least one axially movable forming roller or head 92. The mandrel 90 has a tail stock and clamp 94, which operates to position a cup-shaped blank 96 on the end of the mandrel 90. The mandrel 90 has a shaped outer contour 97 which defines a helical tooth portion 98 sufficiently configured to form complementary helical gear teeth 38 on the internal ring gear 20, shown in FIG. 1.

Referring now to FIG. 3, and with further reference to FIG. 2, the forming roller or head 92 is extended axially along the outer surface of the cup-shaped blank 96 as the mandrel 90 rotates, thereby enforcing flow of the metal within the cup-shaped blank 96. With the spinning process, the metal in the cup-shaped blank 96 will conform to the outer surface of the mandrel 90. That is, the inner surface of the cup-shaped blank 96 will form the helical gear teeth 38, which are complementary to the helical tooth portion 98 of mandrel 90. The internal ring gear 20 and hub portion 42 are formed simultaneously as the forming head 92 moves axially along the cup-shaped blank 96.

FIGS. 4 and 5 illustrate a method of forming the internal ring gear 20 and the hub portion 42 by a powdered metal compaction process. With this operation, a predetermined amount of powdered metal 100 is initially placed within a press 102 having a first die 104 and a second die 106. The first and second die 104 and 106 are preferably manufactured of tungsten carbide or other similar wear-resistant material. The first die 104 has a shaped outer contour 107 which defines a helical tooth portion 108 sufficiently configured to complement the helical gear teeth 38, shown in FIG. 1. A double action pressing operation, wherein the first and second dies 104 and 106 each move axially toward one another, compacts the powdered metal 100 by applying a large axial force. After compaction of the powdered metal 100, the first and second dies 104 and 106 are separated, as shown in FIG. 5, and the integrally formed internal ring gear 20 and hub portion 42 is ejected from the press 102. As illustrated, the helical gear teeth 38 of the internal ring gear 20 are formed complementary with the helical tooth portion 108 on the first die 104.

FIGS. 6 and 7 illustrate a method of integrally forming the internal ring gear 20 and the hub portion 42 by cold extrusion. A cup shaped blank 110 is placed within a cavity 111, which is defined by walls 113 of a cold extrusion press 112. The cold extrusion press 112 includes a die 114 having a shaped outer contour 115 which defines a helical tooth portion 116 sufficiently configured to complement the helical gear teeth 38, shown in FIG. 1. The die 114 is preferably manufactured of tungsten carbide or other similar wear-resistant material. As the die 114 is moved axially into engagement with the cup-shaped blank 110, the high pressures cause the material of the cup-shaped blank 110 to flow between the die 114 and walls 113 thereby producing the integrally formed internal ring gear 20 and hub portion 42. The helical gear teeth 38 of the internal ring gear 20 are formed complementary with the helical tooth portion 116 of die 114. By using the cold extrusion process to integrally form the internal ring gear 20 and hub portion 42, the grain structure and flow of the helical gear teeth 38 is improved.

By integrally forming the internal ring gears 20 and 46 with a respective hub portion 42 and 64, the construction of the first and second planetary gearset 12 and 14 may be simplified. Additionally, the production cost and weight of the first and second planetary gearsets 12 and 14 may be reduced. Also, by integrally forming the internal ring gears 20 and 46 with a respective hub portion 42 and 64, the strength and alignment is improved. By employing a net forming process, i.e. spinning, powdered metal compaction, and cold extrusion, to integrally form the internal ring gears 20 and 46 with a respective hub portion 42 and 64, the strength of the internal ring gears 20 and 46 and the grain structure and flow of the helical gear teeth 38 and 56 is improved. Additionally, the amount of finish machine processes required to finish the internal ring gears 20 and 46 with a respective hub portion 42 and 64 may be reduced.

While the best modes for carrying out the invention have been described in detail, those familiar with the art to which this invention relates will recognize various alternative designs and embodiments for practicing the invention within the scope of the appended claims.

1. A planetary gearset comprising:
an internal ring gear portion having a plurality of generally radially inwardly extending teeth in meshing engagement with at least one pinion gear;
a hub portion extending generally radially inwardly from said internal ring gear; and
wherein said internal ring gear portion and said hub portion are integrally formed.

2. The planetary gearset of claim 1, wherein said plurality of radially inwardly extending teeth are helical in shape.

3. The planetary gearset of claim 1, wherein said hub portion forms at least a portion of a carrier assembly.

4. The planetary gearset of claim 1, wherein said hub portion defines a splined inner surface.

5. The planetary gearset of claim 1, wherein said internal ring gear portion and said hub portion are formed by one of spinning, powdered metal compaction, and cold extrusion.

6. The planetary gearset of claim 1, wherein the planetary gearset is sufficiently configured for use within an automatically shiftable vehicular transmission.

7. A method of integrally forming an internal ring gear and hub portion comprising:
fixturing a blank; and
forming the internal ring gear integrally with the hub portion.

8. The method of claim 7, wherein fixturing said blank includes:
securing said blank to a mandrel having a shaped outer contour defining a tooth portion sufficiently configured to complement gear teeth on the internal ring gear.

9. The method of claim 8, wherein forming the internal ring gear integrally with the hub portion includes:
rotating said mandrel unitarily with said blank; and
urging said blank against said shaped outer contour with a forming head.

10. The method of claim 7, wherein fixturing said blank includes:
placing said blank within a cavity defined by a cold extrusion press, wherein said cold extrusion press includes a die having shaped outer contour defining a tooth portion sufficiently configured to form complementary gear teeth on the internal ring gear.

11. The method of claim 10, wherein said forming the internal ring gear integrally with the hub portion includes:
pressing said die against said blank with sufficient force to urge said blank against said shaped outer contour.

12. A method of integrally forming an internal ring gear and hub portion comprising:
placing a predetermined amount of powdered metal within a press; and
compacting said predetermined amount of powdered metal within said press with sufficient pressure to form the internal ring gear integrally with the hub portion.

13. The method of claim 12, wherein said press includes a first die and a second die, said first die having a shaped outer contour defining a tooth portion sufficiently configured to form complementary gear teeth on the internal ring gear during compacting.

14. The method of claim 12, wherein said compacting said predetermined amount of powdered metal includes a double action pressing operation.
